(19) United States
(12) Patent Application Publication
(10) Pub. No.: US 2017/0366642 A1
(43) Pub. Date: Dec. 21, 2017

(54) USER EXPERIENCE MODIFICATIONS

(71) Applicant: Facebook, Inc., Menlo Park, CA (US)

(72) Inventors: Aryeh Selekman, San Francisco, CA (US); Aigerim Shorman, San Francisco, CA (US); Jeffrey Huang, Mountain View, CA (US); Jeremy Samuel Friedland, San Francisco, CA (US); Aaron David Carambula, San Francisco, CA (US); Ben Chen, San Jose, CA (US)

(21) Appl. No.: 15/186,131

(22) Filed: Jun. 17, 2016

(51) Int. Cl. H04L 29/08; H04L 12/58

(52) U.S. Cl. CPC H04L 67/322; H04L 51/32; H04L 67/18

(57) ABSTRACT

In one embodiment, a method includes accessing a media item associated with a first user of a social-networking system and determining an interest associated with the first user. The method also includes receiving, from the first user, a selection of a user experience modification for the media item, wherein the user experience modification is associated with the determined interest. The method further includes applying the selected user experience modification to the media item associated with the first user.

### TECHNICAL FIELD

This disclosure generally relates to user experience modifications and more particularly to applying user experience modifications to media items on social-networking systems.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g., wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

### SUMMARY OF PARTICULAR EMBODIMENTS

In particular embodiments, an interest associated with a user of a social-networking system is determined. The interest may be determined based on concept nodes that the user is associated with on the social-networking system. The user then selects a user experience modification associated with the determined interest, and the selected user experience modification is applied to a media item associated with the user. In certain embodiments, a suggestion may be sent to the user to apply the user experience modification. The suggestion may include a preview of the user experience modification. In some embodiments, a prompt may be provided to the user for selecting from one or more user experience modifications associated with the determined interest. In certain embodiments, the user experience modification may be provided to the social-networking system by a user associated with a concept node, and suggestions may be sent to users of the social-networking system in response to receiving a request from the user experience modification provider send such suggestions.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example flow diagram of a user experience modification based on a user's interest.

FIGS. 4A-4H illustrate example user experience modifications based on user interests.

FIG. 5 illustrates an example method for modifying a user's media item in accordance with a user experience modification based on a user's interest.

FIG. 6 illustrates an example computer system.

### DESCRIPTION OF EXAMPLE EMBODIMENTS

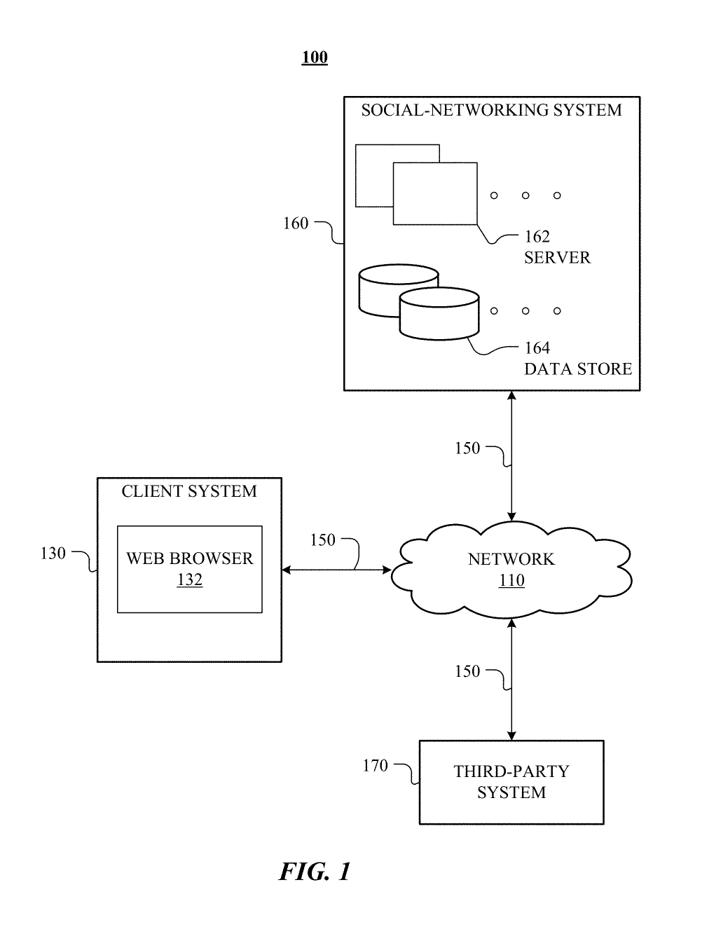

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example, network environment 100 may include multiple client system 130, social-networking systems 160, third-party systems 170, and networks 110.

This disclosure contemplates any suitable network 110. As an example, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example, a client system 130 may include a computer system such as a desktop computer, notebook or laptop computer, netbook, a tablet computer, e-book reader, GPS device, camera, personal digital assistant (PDA), handheld electronic device, cellular telephone, smartphone, augmented/virtual reality device, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example, content objects may include information regarding things or activities of interest to the user, such as, for example, movie show times, movie reviews, restaurant reviews, restaurant menus, product information and reviews, or other suitable information. As another example, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

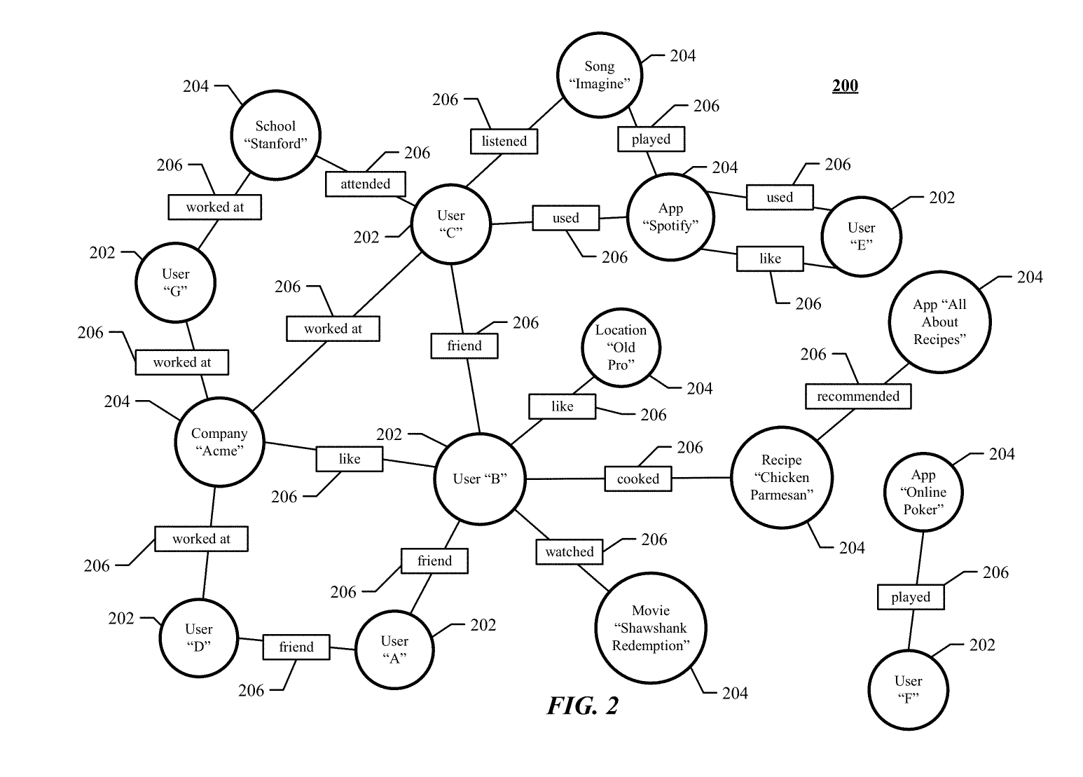

FIG. 2 illustrates example social graph 200. In particular embodiments, social-networking system 160 may store one or more social graphs 200 in one or more data stores. In particular embodiments, social graph 200 may include multiple nodes—which may include multiple user nodes 202 or multiple concept nodes 204—and multiple edges 206 connecting the nodes. Example social graph 200 illustrated in FIG. 2 is shown, for didactic purposes, in a two-dimensional visual map representation. In particular embodiments, a social-networking system 160, client system 130, or third-party system 170 may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of social-networking system 160. As an example, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with social-networking system 160. In particular embodiments, a user node 202 may be associated with information provided by a user or information gathered by various systems, including social-networking system 160. As an example, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages.

In particular embodiments, a concept node 204 may correspond to a concept. As an example, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 204 may be associated with information of a concept provided by a user or information gathered by various systems, including social-networking system 160. As an example, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to social-networking system 160. Profile pages may also be hosted on third-party websites associated with a third-party server 170. As an example, a profile page corresponding to a particular external webpage may be the particular external webpage and the profile page may correspond to a particular concept node 204. Profile pages may be viewable by all or a selected subset of other users. As an example, a user node 202 may have a corresponding user-profile page in which the corresponding user may add content, make declarations, or otherwise express himself or herself. As another example, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 202 corresponding to the user and a concept node 204 corresponding to the third-party webpage or resource and store edge 206 in one or more data stores.

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example, a first user may indicate that a second user is a “friend” of the first user. In response to this indication, social-networking system 160 may send a “friend request” to the second user. If the second user confirms the “friend request,” social-networking system 160 may create an edge 206 connecting the first user's user node 202 to the second user's user node 202 in social graph 200 and store edge 206 as social-graph information in one or more of data stores 164. In the example of FIG. 2, social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example, a user (user “C”) may listen to a particular song (“Imagine”) using a particular application (SPOTIFY, which is an online music application). In this case, social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, social-networking system 160 may create an edge 206 between a user node 202 and a concept node 204 in social graph 200. As an example, a user viewing a concept-profile page (such as, for example, by using a web browser or a special-purpose application hosted by the user's client system 130) may indicate that he or she likes the concept represented by the concept node 204 by clicking or selecting a “Like” icon, which may cause the user's client system 130 to send to social-networking system 160 a message indicating the user's liking of the concept associated with the concept-profile page. In response to the message, social-networking system 160 may create an edge 206 between user node 202 associated with the user and concept node 204, as illustrated by “like” edge 206 between the user and concept node 204. In particular embodiments, social-networking system 160 may store an edge 206 in one or more data stores. In particular embodiments, an edge 206 may be automatically formed by social-networking system 160 in response to a particular user action. As an example, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example, if a user frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 200, social-networking system 160 may analyze the number and/or type of edges 206 connecting particular user nodes 202 and concept nodes 204 when calculating a coefficient. As an example, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example, if a user is tagged in a first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example, social-graph entities that are closer in the social graph 200 (i.e., fewer degrees of separation) may have a higher coefficient than entities that are further apart in the social graph 200.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example, the coefficient may be used to generate media for the user, where the user may be presented with media for which the user has a high overall coefficient with respect to the media object. As another example, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, U.S. Patent Application No. 12/978265, filed 23 Dec. 2010, and U.S. patent application Ser. No. 13/632869, filed 1 Oct. 2012, each of which is incorporated by reference.

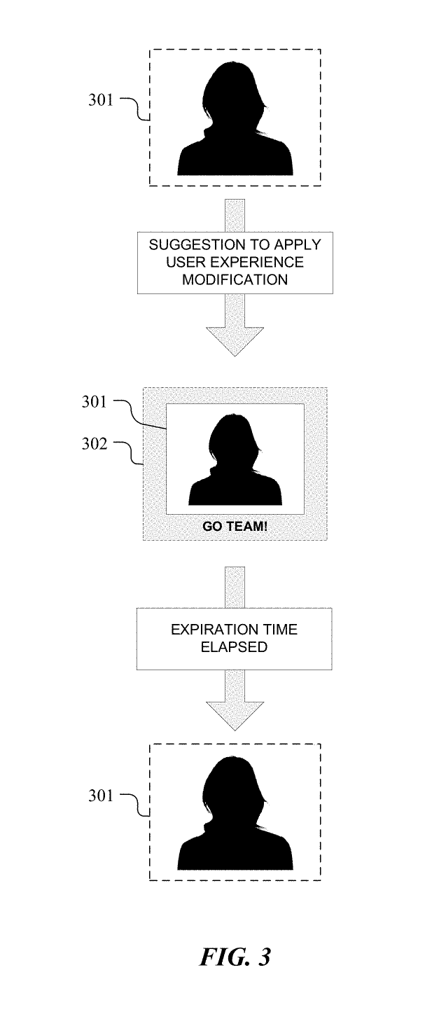

FIG. 3 illustrates an example flow diagram of a user experience modification applied to a user's profile picture 301. The profile picture 301 is an example of a media item associated with the user on the social-networking system. Although FIG. 3 illustrates a user experience modification being applied to a profile picture, the present disclosure contemplates user experience modifications being applied to any suitable media item associated with the user or the user's account on the social-networking system, including images, animations, or videos. Moreover, user experience modifications according to the present disclosure may include any suitable audio or visual modification to a media item associated with the user or the user's account on the social-networking system. In particular embodiments, user experience modifications may include frames, stickers, or other suitable visual modifications to be applied to media items or to portions of media items. For example, a user experience modification may include a frame positioned on top of or around a media item or stickers placed on top of a media item. In certain embodiments, a user experience modification may include the modification of the background of a media item, such as replacing the background with a frame. In certain embodiments, the frame or stickers may be selectably placed by the user on the media item by the user. In certain embodiments, user experience modifications may also include audio clips applied to media items. For example, audio clips may be played in conjunction with videos or animations.

The flow of FIG. 3 begins with the user's current profile picture 301. The user may receive a suggestion to apply one of one or more user experience modifications to her profile picture 301. The suggestion may be generated by one or more computing devices associated with the social-networking system and sent to a computing device associated with the user. For example, the suggestion may be in the form of a post on the social-networking system. In some embodiments, the suggestion may include a suggested user experience modification of the one or more user experience modifications. In some embodiments, the suggestion may include a preview of one of the one or more user experience modifications (e.g., the suggested user experience modification). The preview may show a user experience modification applied to profile picture 301, for example. In some embodiments, the suggestion may include a user experience modification as applied to another user's profile picture (e.g., a friend of the user who has applied the user experience modification to their profile picture), with an indication to the user to “try it now,” referring to applying a user experience modification to her own profile picture. In certain embodiments, a user may “unlock” the ability to apply a user experience modification to his or her profile picture through a donation to an organization, such as a charity.

The suggestion sent to the user may be generated based on any suitable reason or combination of reasons. In particular embodiments, for example, the suggestion may be generated based one or more of the user's interests as indicated on the social-networking system. For example, the suggestion may be generated based on the user's previous indication that the user “likes” a particular sports team, and a suggested user experience modification may indicate the user's support of the sports team. As another example, the suggestion may be generated based on the user's previous indication that the user “attended” a particular university, and a suggested user experience modification may indicate the user's support of the university.

In particular embodiments, the suggestion may be generated based on widely known events. For example, the suggestion may be generated based on a local or national election, and a suggested user experience modification may be based on an aspect of the election itself (e.g., the user experience modification indicates that the user voted in the election) or may indicate a candidate preference of the user. As another example, the suggestion may be generated based on a sports event (e.g., a tournament, game, or match), and a suggested user experience modification may be based on an aspect of the sports event itself (e.g., an outcome of the event) or may indicate a team preference of the user. As yet another example, the suggestion may be generated based on an upcoming holiday, and a suggested user experience modification may indicate a celebration associated with that holiday.

In particular embodiments, the suggestion may be generated based on events associated with the particular user (i.e., events that are not widely known to the public). For example, the suggestion may be based on an upcoming birthday or anniversary of the user, and a suggestion user experience modification may indicate celebration of the birthday or anniversary. As another example, the suggestion may be generated based on an upcoming event that the user has indicated they will be attending, and a suggested user experience modification may indicate the user's excitement about the upcoming event.

In particular embodiments, the suggestion may be generated based on geographic indications by the user. For example, the suggestion may be generated based on a user “checking-in” to a location, such as a stadium, and a suggested user experience modification may include an indication that the user is at the location or an indication of an event occurring at the location (e.g., a sporting event).

In particular embodiments, the suggestion may be generated based on popular news topics (which may sometimes be referred to as “trending” topics). For example, the suggestion may be generated based on a trending hashtag, and a suggested user experience modification may include the hashtag or an indication of the hashtag. As another example, the suggestion may be generated based on the user clicking on a particular trending story or hashtag, or using the hashtag in a post.

In particular embodiments, the suggestion may be generated based on interests associated with other users of the social-networking system. For example, the suggestion may be generated based on friends of the user on the social-networking system sharing an interest (e.g., a particular sports team) with one another, and a suggested user experience modification may include an indication of support for the interest.

In particular embodiments, the suggestion may be generated based on another user applying a user experience modification to their profile picture. For example, a suggestion may be generated to a user after the user's friend has applied a user experience modification to their own profile picture. A suggested user experience modification may be similar to the friend's user experience modification (e.g., may be related to the same interest, such as a particular sport or sports league), but may differ from the friend's user experience modification (e.g., may be for a different team in the sports league).

In particular embodiments, the suggestion may be generated in response to actions by the user on the social-networking system. For example, a suggestion may be generated to the user after the user has “liked” a particular concept node of the social-networking system. As another example, a suggestion may be generated to the user after the user has viewed a profile page associated with the concept node. As yet another example, a suggestion may be generated to a user after the user has viewed a profile picture of another that has a user experience modification applied thereto.

In certain embodiments, the one or more user experience modifications may be produced and provided to the social-networking system by other users of the social-networking system or those associated with concept nodes of the social-networking system. In such embodiments, the suggestions may be generated and sent to users based on “calls to action” (CTAs) that are submitted by the provider of the user experience modification. As an example, a sporting team may manage a concept node on the social-networking system. The team may produce and provide a user experience modification to the social-networking system that indicates support for the team. The team may then submit a CTA to the social-networking system (e.g., through a post) that asks users to apply the user experience modifications to one or more media items (e.g., their profile pictures). The CTA may go to any suitable users of the social-networking system, such as those users who are associated with the team's concept node (e.g., those that have “liked” the concept node associated with the team). The CTA may be presented to the user as a suggestion to apply the provided user experience modification. In certain embodiments, the CTA may present an option to the user to “unlock” a certain user experience modification with a “like” of the user experience modification provider's page, or with a donation of money or other items to the user experience modification provider. The suggestion may be sent to the user in any suitable form, such as those described above.

The user may then select a user experience modification 302 to be applied to profile picture 301. The user experience modification 302 may be selected from one or more suggested user experience modifications in certain embodiments. Once the user has selected a particular user experience modification, it may be applied to the profile picture as illustrated in FIG. 3. The resulting media item may accordingly be used for the user's profile on the social-networking system. The user experience modification 302 applied to the profile picture 301 may be a frame or any other suitable visual modification. For example, in certain embodiments, applying a user experience modification to a media item such as a profile picture may include placing a frame on top of, or around, a current media item, as illustrated in FIG. 3. As another example, in certain embodiments, applying a user experience modification to a media item such as a profile picture may include removing the background of the current media item (e.g., space of the media item that does not include an individual) and replacing it with a frame.

In some embodiments, the user may be given the option to change the media item to which the selected user experience modification is applied, such as by prompting the user to take a new picture for use with the selected user experience modification. When taking the new picture, the selected user experience modification may be indicated to user such that the user may see a preview of how the profile picture to be taken will appear with the user experience modification applied thereto. For instance, the selected user experience modification may be applied to the viewfinder of the device (e.g., the display of a mobile device) used to capture the new media item.

After a particular amount of time has elapsed (an “expiration time”), the profile picture may revert back to profile picture 301 without user experience modification 302 applied thereto. The amount of time may be selected by the user during the selection process associated with the user experience modification. Alternatively, the amount of time may be pre-determined by the social-networking system. In certain embodiments, the profile picture may revert to a different media item than profile picture 301. For example, during the selection process associated with the user experience modification 302, the user may choose to remove the user experience modification 302 after a particular amount of time and replace it with a media item that is different from the media item used for profile picture 301.

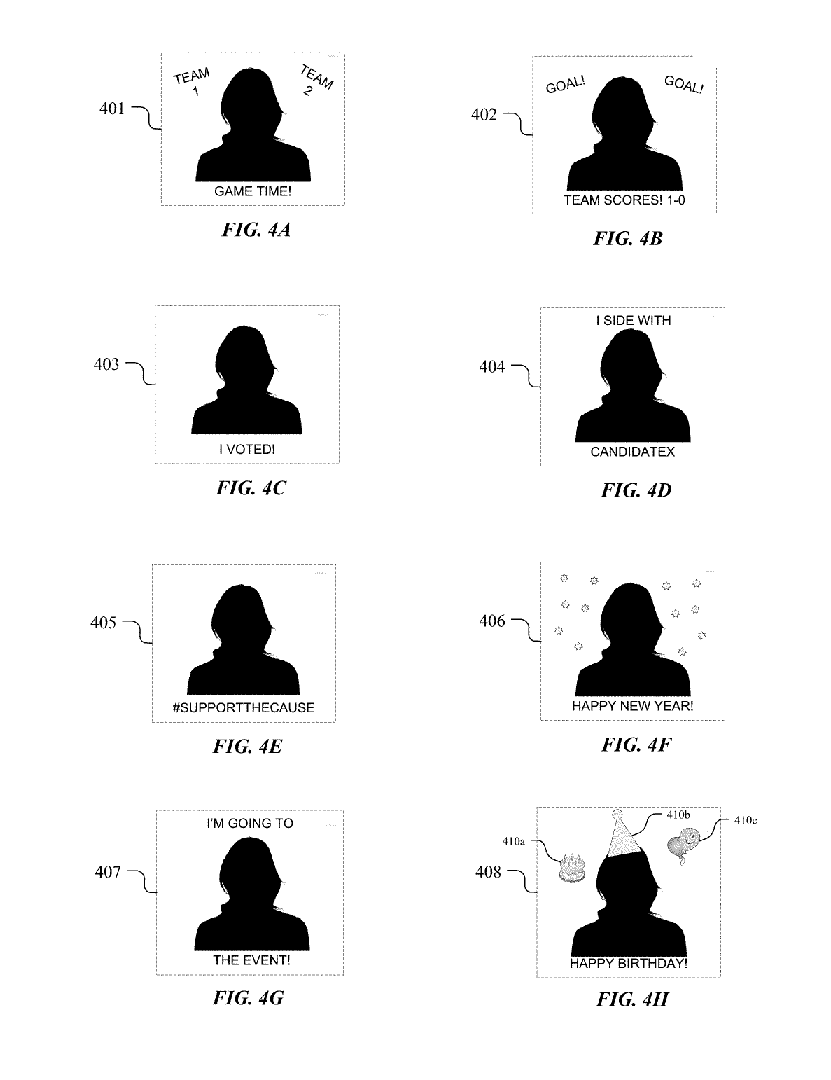

FIGS. 4A-4H illustrate example user experience modifications 401-408 applied to profile pictures. Although illustrated as static modifications in FIGS. 4A-4H, it will be understood that the user experience modifications according to the present disclosure may include dynamic modifications. For instance, one or more portions of the user experience modification may move (e.g., the cake sticker 410a, the hat sticker 410b, and/or the balloons of sticker 410c in FIG. 4H). In addition, the user experience modifications according to the present disclosure may include audio modifications, such as audio clips played along with the presentation of the media item.

FIG. 4A illustrates an example user experience modification 401 that is based on a sporting event. User experience modification 401 may be based on the user previously “liking” a concept node associated with one of the teams participating in the sporting event. User experience modification 401 may be based on the user “checking-in” at a stadium in which the sporting event is being played. In some embodiments, user experience modification 401 may include names of one or more of the teams participating in the sporting event, as illustrated in FIG. 4A.

FIG. 4B illustrates an example user experience modification 402 that is updated during a sporting event. User experience modification 402 may be updated based on or according to the team that the user supports. For example, if the user has previously “liked” the team that is currently ahead, the user experience modification may be updated with a positive or celebratory message as shown in FIG. 4B. However, if the user has previously “liked” the team that is currently behind, the user experience modification may not be updated, or may be updated with an encouraging message (e.g., “WE'RE STILL IN IT!”). User experience modification 402 may be updated periodically, such as every 5, 10, 20, or 30 minutes. User experience modification 402 may be updated after every scoring event in the sporting event.

FIG. 4C illustrates an example user experience modification 403 that is based on an election. User experience modification 403 may be based on the social-networking system asking whether the user has voted in the election. User experience modification 403 may be based on the user checking-in to a known voting location.

FIG. 4D illustrates an example user experience modification 404 that is based on a user's support of a political candidate. User experience modification 404 may be based on or in response to the user “liking” the candidate's concept node profile page. User experience modification 404 may be based on a CTA submitted by a political candidate or representatives thereof.

FIG. 4E illustrates an example user experience modification 405 that is based on a trending news topic. User experience modification 405 may be based on a trending hashtag, and may include the hashtag therein as illustrated in FIG. 4E.

FIG. 4F illustrates an example user experience modification 406 that is based on a national holiday. User experience modification 406 may be based on religious holidays as well. For example, user experience modifications based on religious holidays may be based on the user previously indicating their religion in the social-networking system.

FIG. 4G illustrates an example user experience modification 407 that is based on a event that the user has indicated they will attend. User experience modification 407 may be based on publicly-known events or smaller non-publicly known events, such as those setup between a few friends.

FIG. 4H illustrates an example user experience modification 408 that is based on a personal event. User experience modification 408 may be based on any suitable personal event, such as birthdays or wedding anniversaries. User experience modification 408 includes an example frame (i.e., the portion indicating “Happy Birthday”) and example stickers 410a-c positioned on the media item. Stickers 410a-c may be selectably placed by the user on the media item, in certain embodiments, such as when the user is selecting user experience modification 408.

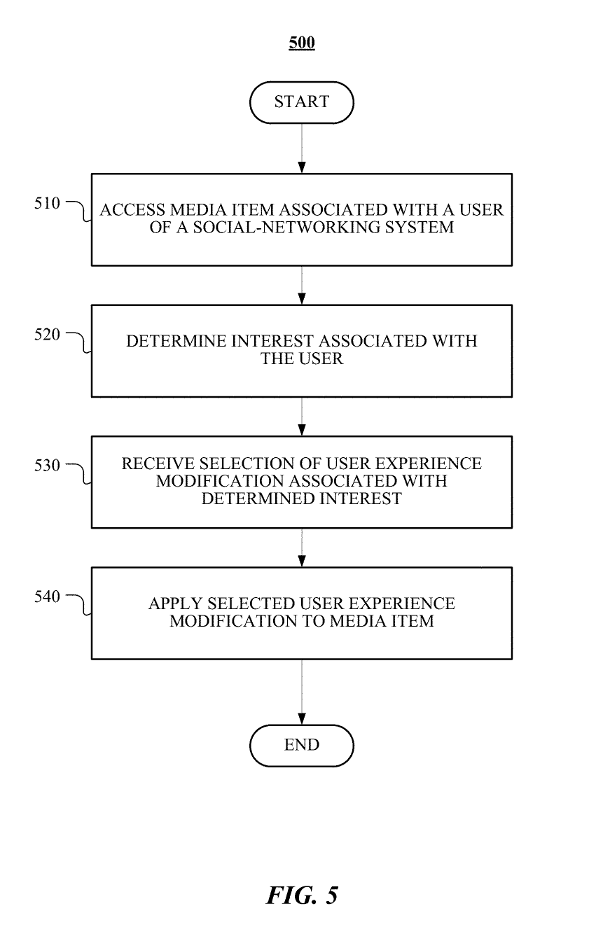

FIG. 5 illustrates an example method 500 for applying user experience modifications to a media item based on a user's interest. The method begins at step 510, where a media item associated with a first user of a social-networking system is accessed. The media item may be accessed by one or more computing devices associated with a social-networking system, such as social-networking system 160 of FIG. 1. The media item may be an image, video, or animation.

In particular embodiments, the media item may be a current profile picture associated with the first user on the social-networking system, similar to profile picture 301 of FIG. 3. In other embodiments, the media item may be a picture associated with the first user on the social-networking system that is not the user's current profile picture. In certain embodiments, the media item may be received by the one or more computing systems before it is accessed. For example, the first user may supply a new media item to the social-networking system during step 510, such as by taking a new picture or video.

At step 520, one or more interests associated with the first user of the social-networking system are determined. In particular embodiments, the one or more interests may be determined based on concept nodes that the first user is associated with on the social-networking system. For example, an interest may be determined based on the first user “liking” a particular concept node or particular concept nodes that are similar to one another (e.g., bands that play music of a particular type).

In certain embodiments, the one or more interests may be determined based on concept nodes that are associated with the first user's friends on the social-networking system. For example, an interest may be determined based on a certain number (e.g., greater than 5 or 10) of the first user's friends being associated with a particular concept node (e.g., a university or employer).

At step 530, a selection is received from the first user indicating a user experience modification associated with the interest determined at step 520. The user experience modification may be any suitable visual or audio modification to be applied to a media item. For example, the user experience modification may include a frame or stickers positioned around or on top of the media item. As another example, wherein the media item includes an animation or video, the user experience modification may include one or more audio clips to be played in conjunction with the media item.

The selection may be received in response to a suggestion generated to the first user to apply a user experience modification to a media item associated with the first user. In some embodiments, the selection may be made in response to a prompt provided to the first user providing for selecting from one or more user experience modifications associated with the interest determined at step 520. In some embodiments, the suggestion may include a preview of the user experience modification applied to a media item associated with the first user (e.g., the media item accessed at step 510).

In certain embodiments, the user experience modification may be received by the social-networking system from a second user of the social-networking system, and the suggestion may be generated based on a request received from the second user. For example, the user experience modification may be produced and provided to the social-networking system by a second user that is associated with a concept node of the social-networking system. The suggestion may be sent to the first user based on a CTA request submitted by the user experience modification provider (i.e., the second user associated with the concept node).

In certain embodiments, the suggestion may be generated based on an event associated with the determined interest. For example, a concept node may generate an event on the social-networking system (e.g., for a sporting event) and the suggestion may be generated to the first user on the date that the event is occurring. Further, in some embodiments, the selected user experience modification may be based on the event, and the user experience modification may be updated based on the event. For example, a user experience modification selected by the user may indicate a sporting event that is currently being played. The user experience modification may update as necessary (e.g., periodically or as the score changes) to reflect certain events that occur during the sporting event.

In particular embodiments, the suggestion may be generated based on a determination of the first user's current location. For example, the first user may “check-in” to a stadium, and the suggestion may be generated to the user based on the “check-in.” The suggestion may include a suggested user experience modification that indicates an event occurring at the stadium during or near the time that the first user “checked-in” to the stadium.

The selection of step 530 may indicate that the user experience modification is to be performed on the media item accessed at step 510, or to be performed on another media item associated with the first user. The selection may also indicate an expiration time for the selected user experience modification. For example, during the selection process, a prompt may be provided to the first user for selecting an expiration time for the selected user experience modification. This may include providing a link to the user to select from one or more pre-determined expiration time options, or may include asking for input from the first user as to a particular desired expiration time. After the selected expiration time, the user experience modification may be removed from the media item. This may include modifying the media item to revert back to the media item as it was before the user experience modification was applied. For example, the profile picture may revert back its original state before applying the user experience modification. In certain embodiments, however, this may include changing the media item to another media item. For example, the profile picture may change to a different one than that used prior to or with the user experience modification applied thereto.

At step 540, the user experience modification selected at step 530 is applied to the media item associated with the first user. This may include modifying the media item in accordance with the selected user experience modification. In particular embodiments, after applying the user experience modification to the media item associated with the first user, the social-networking system may generate a suggestion to a friend of the first user (i.e., a second user associated with the first user on the social-networking system). The suggestion may indicate a user experience modification of one or more user experience modifications associated with the interest determined at step 520. For example, the suggestion may be generated to the friend if the friend shares the same interest as the first user.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method for modifying a user's media item in accordance with a user experience modification based on a user's interest including the particular steps of the method of FIG. 5, this disclosure contemplates any suitable method for modifying a user's media item in accordance with a user experience modification based on a user's interest including any suitable steps, which may include all, some, or none of the steps of the method of FIG. 5, where appropriate. Furthermore, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

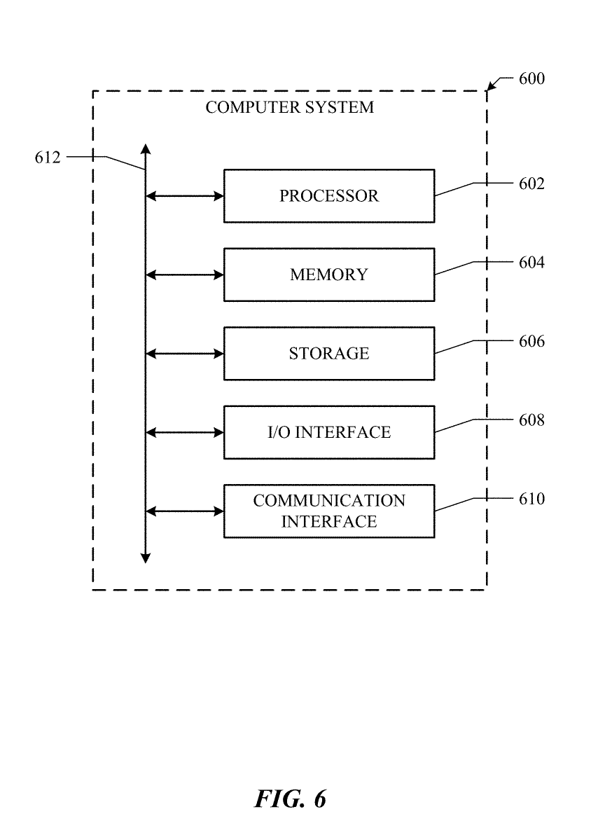

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by one or more computing devices, accessing a media item associated with a first user of a social-networking system;
by the one or more computing devices, determining an interest associated with the first user;
by the one or more computing devices, receiving, from the first user, a selection of a user experience modification for the media item, wherein the user experience modification is associated with the determined interest; and
by the one or more computing devices, applying the selected user experience modification to the media item associated with the first user.

2. The method of claim 1, further comprising, by the one or more computing devices, generating a suggestion to the first user to apply one of one or more user experience modifications associated with the determined interest.

3. The method of claim 2, further comprising, by the one or more computing devices, receiving a user experience modification of the one or more user experience modifications from a second user of the social networking system, and wherein the suggestion is generated based on a request received from the second user.

4. The method of claim 2, wherein the suggestion includes a preview of the user experience modification.

5. The method of claim 2, wherein the suggestion is generated based on an event associated with the determined interest.

6. The method of claim 5, wherein the user experience modification is based on an event associated with the determined interest.

7. The method of claim 6, further comprising, by the one or more computing devices, updating the user experience modification based on the event.

8. The method of claim 2, further comprising, by the one or more computing devices, providing a prompt to the first user for selecting from the one or more user experience modifications associated with the determined interest.

9. The method of claim 1, wherein accessing a media item associated with the first user comprises receiving the media item from the first user.

10. The method of claim 1, wherein determining an interest associated with the first user is based on concept nodes that the first user is associated with on the social-networking system.

11. The method of claim 1, further comprising, by the one or more computing devices, determining a location of the first user, wherein determining an interest associated with the first user is based on the determined location.

12. The method of claim 1, further comprising:
by the one or more computing devices, providing a prompt to the first user for selecting an expiration time for the selected user experience modification; and
by the one or more computing devices, removing the selected user experience modification from the media item after the selected expiration time.

13. The method of claim 1, further comprising, by the one or more computing devices, generating a suggestion to a second user of the social-networking system to apply a user experience modification of the one or more user experience modifications associated with the determined interest, the second user being associated with the first user on the social networking system.

14. The method of claim 1, wherein the media item comprises an image, video, or animation, and wherein the user experience modification comprises a frame, stickers, or other visual modifications to be positioned around or on top of the media item.

15. The method of claim 1, wherein the media item comprises a video or animation, and wherein the user experience modification comprises one or more audio clips to be played in conjunction with the media item.

16. One or more computer-readable non-transitory storage media embodying software that is operable when executed to:
access a media item associated with a first user of a social-networking system;
determine an interest associated with the first user;
receive, from the first user, a selection of a user experience modification for the media item, wherein the user experience modification is associated with the determined interest; and
apply the selected user experience modification to the media item associated with the first user.

17. The media of claim 16, wherein the software is further operable when executed to generate a suggestion to the first user to apply one of one or more user experience modifications associated with the determined interest.

18. The media of claim 17, wherein the software is further operable when executed to receive a user experience modification of the one or more user experience modifications from a second user of the social networking system, and wherein the suggestion is generated based on a request received from the second user.

19. The media of claim 16, wherein the software is operable to determine an interest associated with the first user based on concept nodes that the first user is associated with on the social-networking system.

20. A system comprising: one or more processors; and a memory coupled to the processors comprising instructions executable by the processors, the processors being operable when executing the instructions to:
access a media item associated with a first user of a social-networking system;
determine an interest associated with the first user;
receive, from the first user, a selection of a user experience modification for the media item, wherein the user experience modification is associated with the determined interest; and
apply the selected user experience modification to the media item associated with the first user.
